(19) United States
(12) Patent Application Publication
(10) Pub. No.: US 2002/0085689 A1
(43) Pub. Date: Jul. 4, 2002

(54) Method and apparatus for remote scheduling

(76) Inventor: Stacy Chin, San Diego, CA (US)

Correspondence Address: Nokia Inc., Attn: Brian T. Rivers, Esq., 6000 Connection Drive, Irving, TX, 75039, US

(21) Appl. No.: 09/754,234

(22) Filed: Jan. 3, 2001

(51) Int. Cl. H04M 1/64; G06F 7/00; H04M 3/42

(52) U.S. Cl. 379/88.13; 340/7.23; 455/414; 379/67.1

(57) ABSTRACT

An electronic device and method operable in a wireless communication system, where the electronic device can transmit and receive confirmation or rejection messages for a proposed meeting. The proposed meeting message and response message can be automatically transmitted to a plurality of users, wherein the messages can be voice, text or a combination of voice and text.

### FIELD OF THE INVENTION

The present invention relates to an apparatus and method for remote scheduling, more particularly to an apparatus and method operable in a wireless communication system to send and receive scheduling information.

### BACKGROUND OF THE INVENTION

A communication system is operable to communicate information between a transmitting station, also referred to as a calling party, and a receiving station, also referred to as a receiving or called party, by way of a communication network. Operation of a wireless communication system transfers information between the transmitting and receiving stations via one or more base stations. Within this wireless communication system various types of radio technology, each defined by a standard, are used to effect information transfer. These standards have been established and the wireless communication systems are generally constructed to be operable in compliance with one or more of these standards. Among these standards are currently accepted versions for AMPS (Advanced Mobile Phone System), GSM (Global System for Mobile Communications), cellular and digital communications such as TDMA (Time Division Multiple Access) and CDMA (Code Division Multiple Access). The digital communications encompassing the CDMA communication system are exemplary of a broadband multi-user wireless communication system. For example, IS-95/IS-2000 defines an existing standard for CDMA wireless communication systems.

With the expansion of wireless communication systems to larger geographical areas the capability to reach a desired receiving station is increased. As a consequence an operator, also called a user, of the receiving station can receive information in locations where it may be difficult to record this information and check schedule availability. Typically, the receiving station user must employ other resources such as a notepad, daily planner, calendar or PDA (Personal Digital Assistant) to insure compatibility of the received information with the user's schedule. This requirement to provide schedule compatibility is an inconvenient and time-consuming practice to which the user can be provided with a better alternative.

It would be useful if the calling party could provide a query message to the receiving station wherein the query could prompt a check of the receiving party's schedule and receive confirmation or rejection of the proposed information via a response message. Furthermore, it would be useful if the calling party could send a meeting query to several distinct receiving stations and automatically receive confirmations or rejection of proposed time and date of the meeting query.

### SUMMARY OF THE INVENTION

The present invention encompasses an electronic device, such as a mobile terminal, a personal digital assistant (PDA) or a portable computer, which may be operated in a communication system (for example CDMA, TDMA, GSM, etc.). The apparatus and method of the present invention comprises a remote scheduling feature where a query message can be sent from a transmitting station to one or more receiving stations. The transmitting station may also receive a query message response from a receiving station and the response may be automatically recorded. The response message may be a confirmation or rejection of the query message. Additionally, the transmitting station may also receive a query message from one or more transmitting stations, record the query message in memory and subsequently send a response message to the transmitting stations.

A more complete appreciation of all the advantages and scope of the present invention can be obtained from the accompanying drawings, the following detailed description of the invention and the appended claims.

### BRIEF DESCRIPTION OF THE DRAWINGS

FIG. 1 illustrates a block diagram of a mobile station into which an embodiment of the present invention may be implemented.

FIG. 2A illustrates a communication system into which an embodiment of the invention may be operated.

FIG. 2B illustrates a transmitted query message, or response message, depiction of an embodiment of the present invention.

FIG. 2C illustrates a received response message, or query message, depiction of an embodiment of the present invention.

FIG. 3 illustrates an embodiment of the present invention where a first mobile station is capable of transmitting a query message to a plurality of receiving stations, and receiving a response message from the plurality of receiving stations.

FIGS. 4a-d illustrate a flow diagram for sending a query message and receiving a response message according to an embodiment of the present invention.

### DETAILED DESCRIPTION OF THE INVENTION

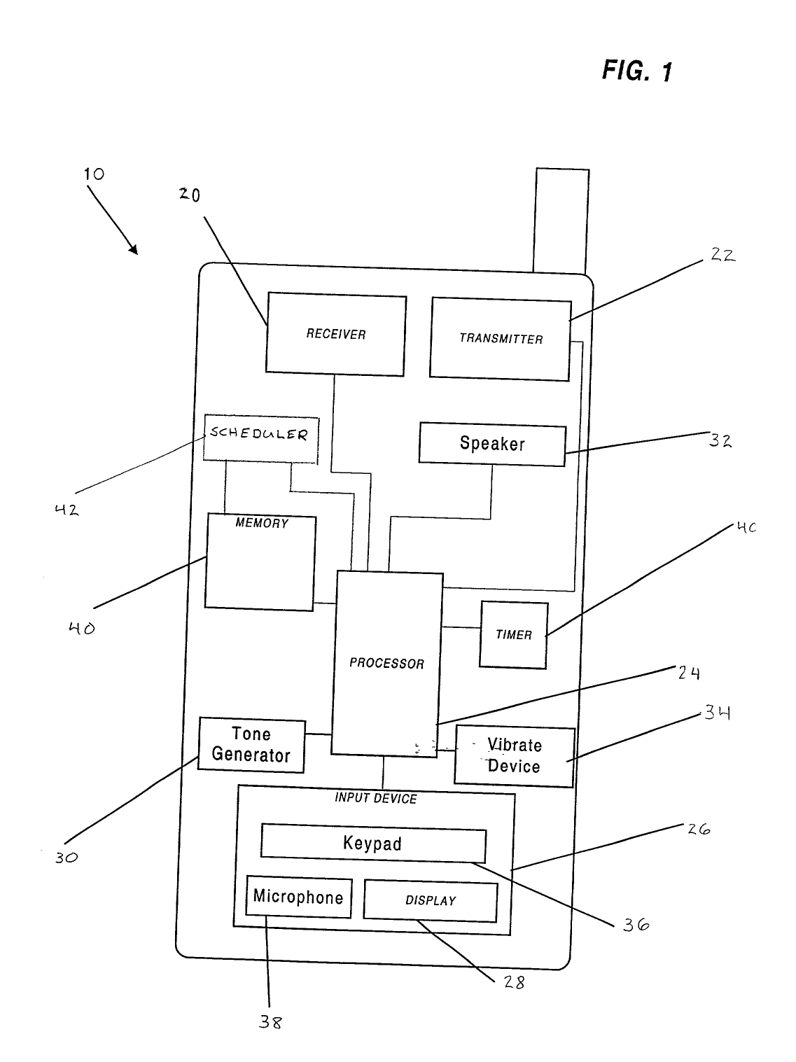

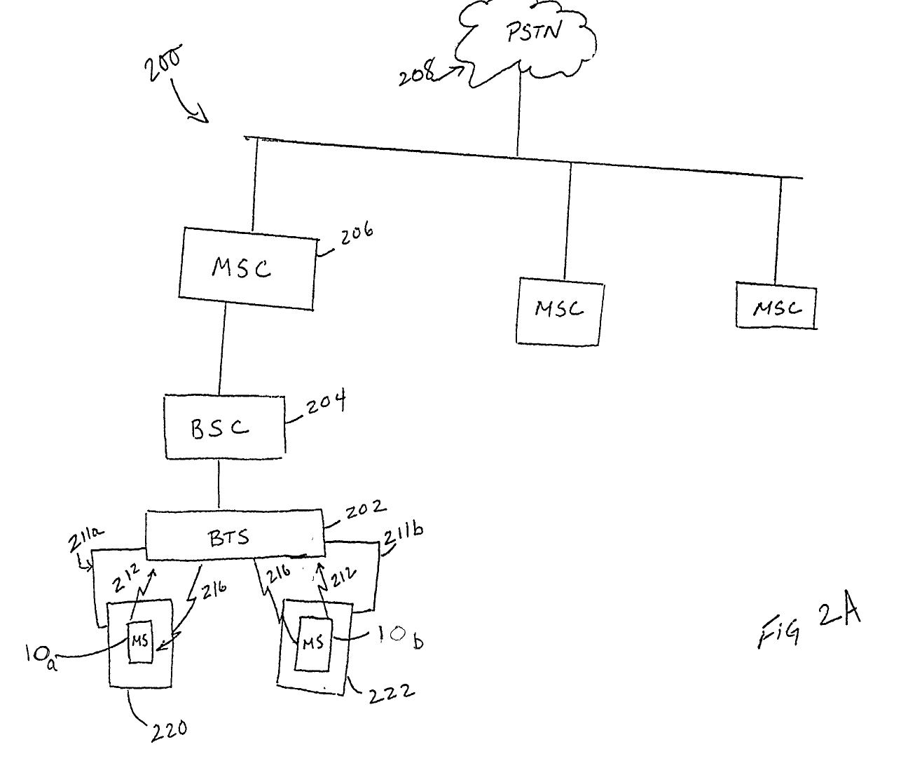

FIG. 1 is a block diagram of a mobile station 10, according to an embodiment of the present invention. Generally, the mobile station 10 includes a receiver 20, a transmitter 22 and a controller or processor 24 that is coupled to the receiver 20 and the transmitter 22. The receiver 20 sends incoming messages to the processor 24 for analysis, whereas outgoing or originating messages are sent from the processor 24 to the transmitter 22. These incoming and originating messages can be in the form of a voice message, a text message (also known as a data message) or a combination of voice and text messages.

User interface with the mobile station 20 can be accomplished via an input device 26 which may comprise: a Liquid Crystal Display (LCD) 28 which can contain a touch-screen display (not shown), or a Light Emitting Diode (LED) (not shown); a tone generator 30; a speaker 32; a vibrating device 34; and a vibration device 34. In one embodiment, the keypad 36 is an alpha-numeric keypad (not shown) and the input device 26 further contains a microphone 38 capable of capturing the voice message. In addition, a timer 40, also known as a clock chip, can be used for synchronizing the operations of the processor 24 and tracking time, a term well known to those of ordinary skill in the art of mobile stations. Communication between the input device 26, the tone generator 30 and the vibrating device 34 is assured by coupling these devices to the processor 24.

The mobile station 10 also includes various storage locations, illustrated in the embodiment of FIG. 1 as a memory 40 and a scheduler 42, where the memory 40 and the scheduler 42 are capable of storing a plurality of data used by processor 24 in the operation of the mobile station 10. Locating the scheduler 42 within the memory 40 is also within the scope of the present invention, as the information entered into the scheduler 42 may be from a database external to the mobile station 10, for example an Internet site. In addition, the memory 40 can store the values of the various feature parameters, operating system used by processor 24, user provided data entered via the input device 26 and sub-programs or sub-processes for controlling the operation of the mobile station 10. The scheduler 42 may contain programming routines to transmit or receive a query message to one or more receiving stations. When sending a query message, the scheduler 42 can automatically transmits the query message to a preselected list of receiving stations and awaits a response message to the query message, where the response message can be either a confirmation or a rejection. Upon receiving the query message the scheduler 42 can check availability and send either the confirmation or rejection response message to the receiving station.

In another embodiment the mobile station 10 can act as a receiving station for a query message transmitted from an originating, or transmitting station. In this instance, the query message is received and sent to the memory 40; the processor 24 compares the query message to the scheduler 42; the processor 24 composes the response message and stores the response method in the memory 40; the response message is then transmitted to the originating station.

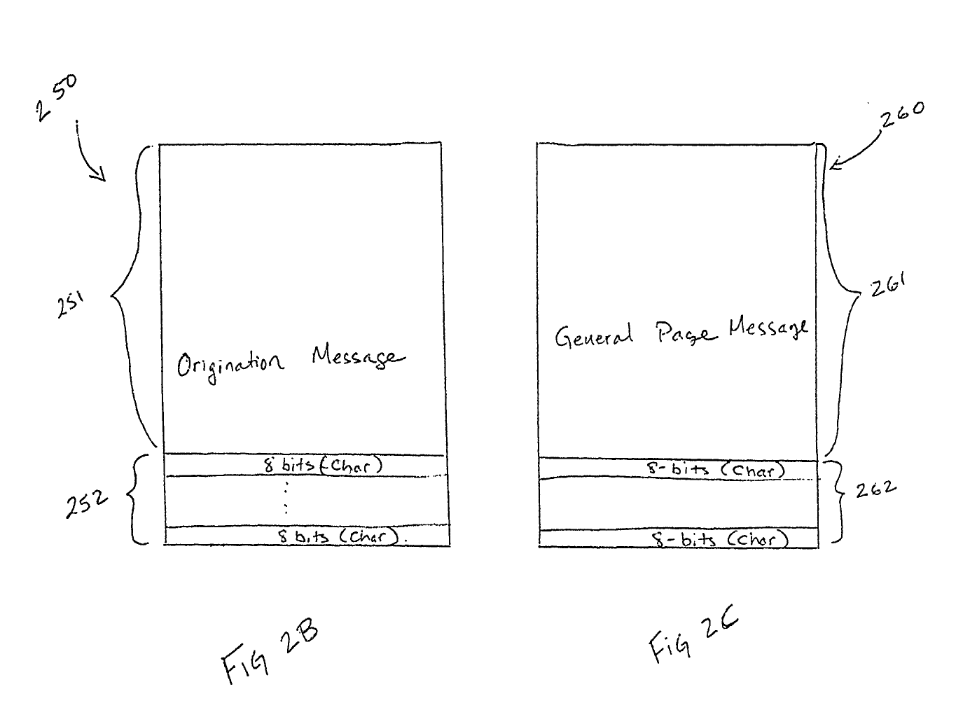

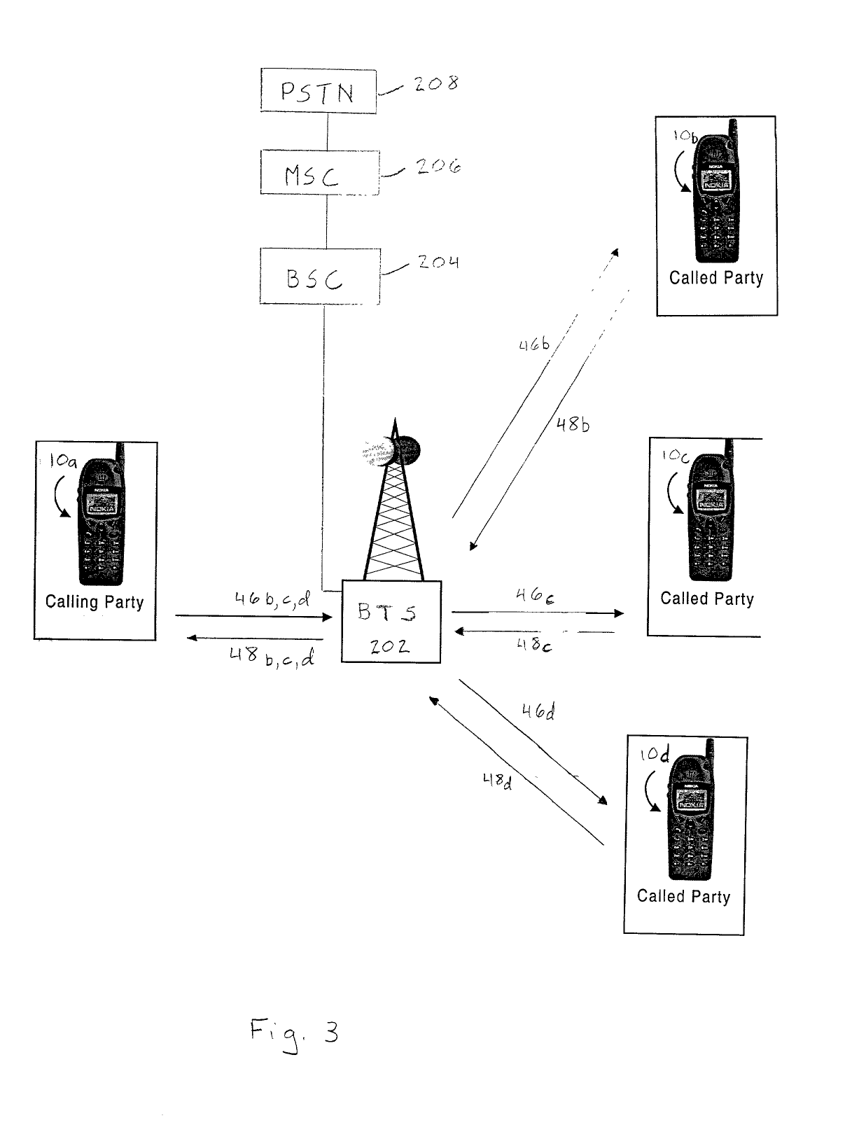

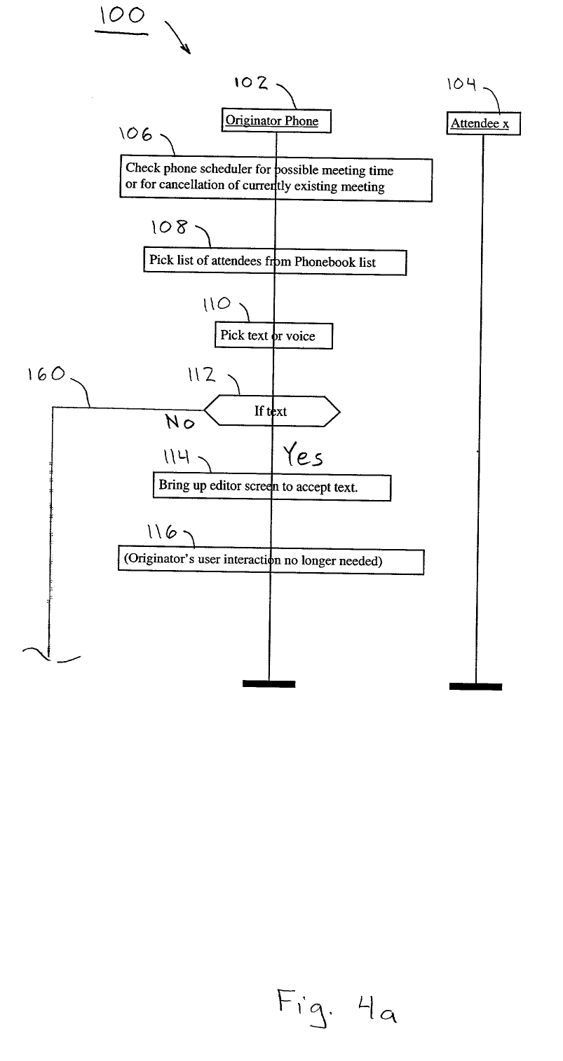

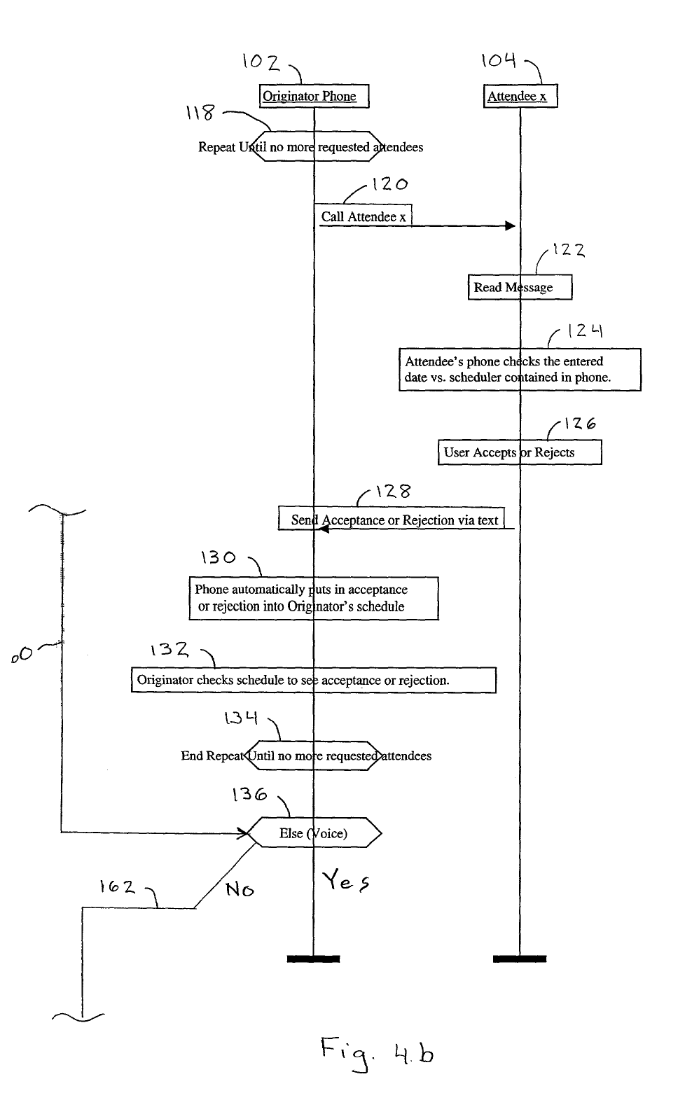

The details of a multi-user communication system for the CDMA IS-95/IS-2000 standard are illustrated in FIG. 2A, where the multi-user communication system is generally depicted as 200. A Base Transceiver Station (BTS) 202 is operable to transceiver communication signals with one or more mobile stations, illustrated as a mobile station 10a for transmitting and a mobile station 10b for receiving communication, via a radio link 211a and 211b, respectively, for communication within a fixed geographical region. The BTS 202 is coupled to a Base Station Controller (BSC) 204, wherein the BSC 204 exerts control authority over the BTS 202. Furthermore, the BSC 204 is coupled to a Mobile Switching Center (MSC) 206 followed by connection to a Public Switched Telephone Network (PSTN) 208. A complete communication path, also called communication link, provides a transmission route from the mobile station 10a, through the radio link 211a to the BTS 202, BSC 204, MSC 206 and PSTN 208, followed by reversing the order from PSTN 208 until reaching BTS 202, where radio link 211b reaches the mobile station 10b.

In an embodiment of the present invention, the originating, or calling party, initiates a call by using a calling sequence by transmitting an outgoing call request which includes an Origination Message (OM) and a General Page Message (GPM), both defined in “Upper Layer (Layer 3) Signaling Standard for CDMA2000 Spread Spectrum Systems” published as TIA/EIA/IS-2000-5-A, 2000, hereinafter referred to as IS-2000 Standard. As an example in FIG. 2A, a forward link 212 represents transmission of the OM from the mobile station 10a to the BTS 202, and reverse link 216 represents GPM transmission from BTS 202 to the mobile station 10b. The present embodiment of the communication system 200 includes modification of the OM and GPM pursuant to IS-2000A standard to include provisions for the query message and the response message.

FIG. 2B illustrates an exemplary transmitted call request 250 having additional bits representing a transmitted query message notification 252. In the exemplary transmitted message call request 250, plurality of bits representing the query message notification 252 are added to an Origination Method 251 pursuant to IS-2000A standard. The plurality of bits for query message notification 252 may represent a schedule including one or more receiving stations 10, time, date, length of meeting and purpose of meeting. The plurality of bits may be represented by alphanumeric characters, and depending on manufacture, the length of the characters may range from 1-150 characters.

FIG. 2C represents an exemplary received call request 260 having additional bits representing a response message notification 262. In the exemplary received call request 260, plurality of bits representing the response message notification 262 are added to a General Page Message 261 pursuant to the IS-2000A standard. The plurality of bits for response message notification 262 may represent acknowledgement, rejection or change information for time, date, length of meeting and purpose of the meeting. Again, the plurality of bits may be represented by alphanumeric characters and having length substantially similar to query message notification 252. While the following description shall describe the operation of an embodiment of the present invention with respect to a communication system operable pursuant to the IS-2000A standard and modified messages 250 and 260, other implementations of the present invention can analogously be implemented in other types of communication systems.

In an exemplary communication system according to the IS-2000A standard, a calling party 220 comprising the mobile station 10a, transmits the call request 250, shown in FIG. 2B, to the BTS 202. The BTS 202 extracts information from the call request 250, such as phone number of a receiving party 222, and attempts to locate the receiving party 222 comprising the mobile station 10b. Once the BTS 202 locates the receiving party 222, the BTS 202 generates the received call request 260 using information from the transmitted call request 250, and transmits the received call request 260 to the mobile station 10b associated with the receiving party 222. A two-way communication link between the calling party 220 and the receiving party 222 may be established upon the receiving party 222 accepting the transmitted call request 250.

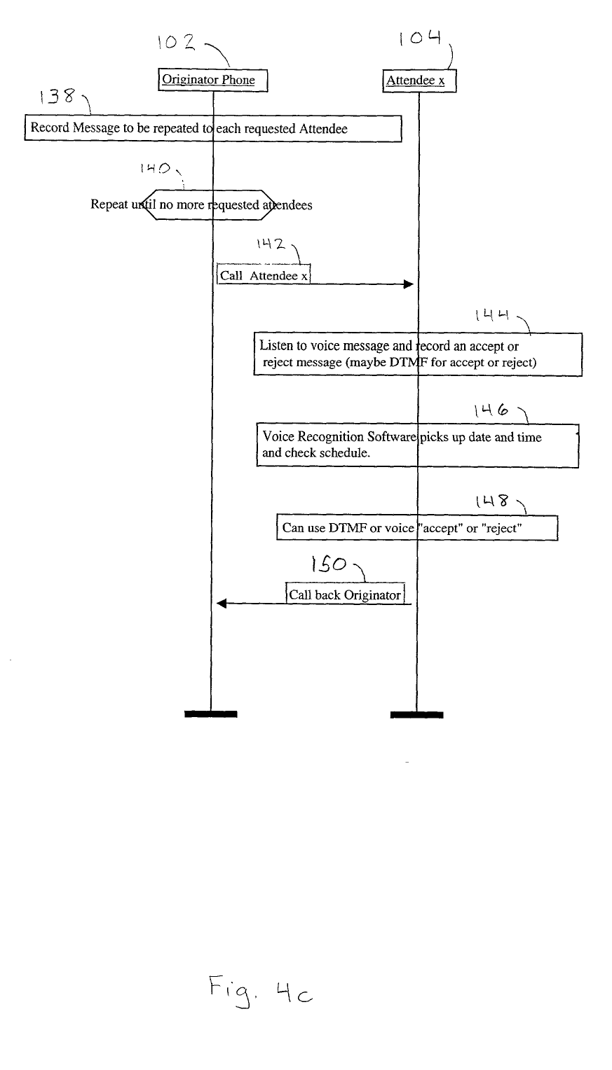

As shown in FIG. 3, the mobile station 10a can communicate with a plurality of electronic devices operable in a wireless communication system, specifically second, third and fourth mobile stations, 1Ob, 1Oc and 10d respectively, via the BTS 202. The communication path is the same as illustrated and described in FIG. 2A, however, for brevity only those signals to and from the BTS 202 are described. The mobile station 10a transmits a signal 46b,c,d to the BTS 202 where a signal 46b reaches the second mobile station 10b. Likewise, signals 46c and 46d reach the third and fourth mobile stations, 10c and 10d respectively. A response 48b is sent from the second mobile station 10b to the BTS 202 and on to the mobile station 10a as a response 48b, c, d. Likewise, signals 48c and 48d reach the BTS 202 and on to the mobile station 10a via the signal 48b,c,d.

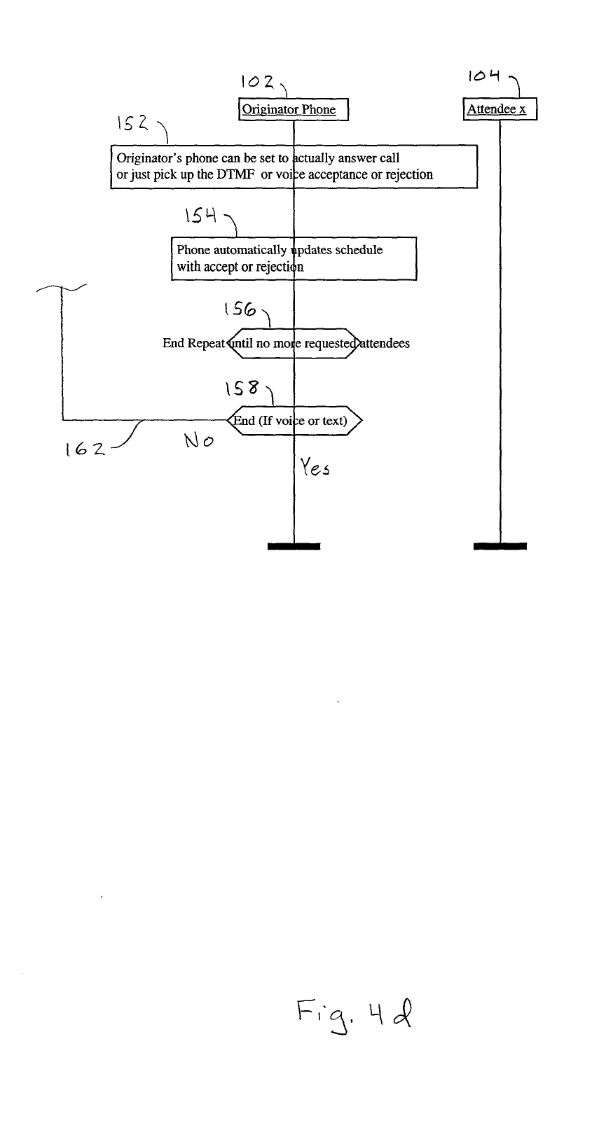

Referring to FIGS. 4a-d, a method flow diagram 100 providing an embodiment of the present invention. Blocks 102-116 define the user composing a first query message (for example a text message or a voice message). A block 102 represents a first, or originator, mobile station 10 capable of communicating with at least one electronic device operable in a wireless communication system, generally designated in block 104 as attendee x (receiving station), where x can be any integer number starting at 1 (for example x =1, 2, 3, etc.). At block 106 the user of the mobile station 102 can check the scheduler 42 for appointments or meetings and select a list of one or more attendees, as outlined in block 108, from a database within the scheduler 42. Furthermore, the database can be stored within the scheduler 42, the memory 40 or accessed from a remote location, for example an Internet site. User defined selection of text message, voice message or a combination of text and voice message is the subject of block 110. If a text message is selected at block 112, the user can enter text via the input device 36 to an editor screen (not shown) on the display 28, and this stage defines the last required interaction with the user, as described in block 116.

Block 118 defines the start of a repeating section for each attendee designated to receive the text message. At block 120 the processor 24 transmits the text message (first query message) to attendee x (receiving station) of block 104, where the text message is received at block 122, availability is checked at block 124 and a text response (first query response) message in the form of an acceptance or rejection is transmitted to the mobile station 102 by the receiving station, as provided in blocks 126 and 128 respectively. Response 126 is automatically recorded into the scheduler 42, as shown at block 130, and the user of the mobile station 102 can subsequently check the response message, as presented in block 132. Block 134 requires the cycle encompassing blocks 118 through block 132 be conducted to cover all attendees, as designated by the x in block 104. In other words, if x=1 (1 attendee) the operations of blocks 118 through 132 is conducted only once, if x=4 (4 attendees) the operations of blocks 120 through 128 are conducted 4 times, and so on for any number of attendees x of block 104.

Block 136 designates the process starting point for generating the voice message. An option in recording the voice message, block 138, can encompass a generic voice message to address all attendees, or an individual voice message unique to each attendee. When recording the individual voice messages, the procedure is repeated until all attendees have been addressed, block 140, and the voice messages are automatically transmitted to the respective receiving stations, as shown in block 142. The attendee can listen to the voice message and compose a response voice message, as in block 144, where the response voice message can be an acceptance or ejection. An alternative embodiment to listening and responding to the voice message is embodied in block 146, where voice recognition software is used to automatically analyze and comprehend the query message, and compare availability of attendee's schedule to that proposed in the query message. Another alternative embodiment is sending the response message via Dual Tone Multifrequency (DTMF) signals, where acceptance is assigned a first tone and rejection is assigned a second tone. Block 150 signifies the transmission of the response message to the mobile station 102, where the response message can be answered and automatically entered into the scheduler 42, as noted in blocks 152 and 154 respectively. Block 156 requires the cycle encompassing blocks 142 through block 156 be conducted to encompass all attendees, as designated by the x in block 104. In other words, if x=1 (1 attendee) the operations of blocks 142 through 156 is conducted only once, if x=4 (4 attendees) the operations of blocks 142 through 156 are conducted 4 times, and so on for any number of attendees x designated in block 104. Block 158 denotes the last step in the scheduling sequence.

If a voice message is selected at block 110, the text procedure can be bypassed via line 160 going directly to block 136. Alternatively, if a text message is selected at block 110, the voice procedure can be bypassed via line 162 going directly to block 158. When utilizing a combination of voice and text messages the full procedure is conducted from block 102 through block 158.

It is understood that various modifications can be made to the mobile station apparatus and method of operation and remain within the scope of the present invention. For example, the mobile station may comprise a PDA, mobile phone, computer, etc., and may be operated under any number of radio technologies, including AMPS, GSM, CDMA and all other known and developing systems.

While preferred embodiments have been discussed and illustrated above, the present invention is not limited to these descriptions or illustrations, and includes all such modifications which fall within the scope of the invention and claim language presented below.

What is claimed is:

1. An electrical device operable in a wireless communication system, the electrical device comprising:
a memory for storing a schedule and address of a receiving station;
a scheduler for composing the schedule; and
a processor for generating a first query message upon completion of the schedule and transmitting the first query message to the receiving station; the processor further receiving a first response message from the receiving station and recording the first response message in the memory.

2. The electrical device as claimed in claim 1, wherein the processor further receives a second query message from a transmit station and the memory records the second query message; the processor further generates and transmits a second response message upon recording the second query message.

3. The electrical device as claimed in claim 1, wherein the first query message comprises a voice message.

4. The electrical device as claimed in claim 1, wherein the first query message comprises a text message.

5. The electrical device as claimed in claim 1, wherein the first query message comprises a meeting request.

6. The electrical device as claimed in claim 1, wherein the first response message comprises a voice message.

7. The electrical device as claimed in claim 1, wherein the first response message comprises a text message.

8. The electrical device as claimed in claim 1, wherein the first response message comprises a dual tone multifrequency response.

9. An electrical device operable in a wireless communication system, the electrical device comprising:
a processor for receiving a first query message from a transmit station; the processor recording the first query message and generating a first response message upon recording the first query message; the processor further transmitting the first response message to the transmit station upon generating the first response message.

10. The electrical device as claimed in claim 9 further comprising:
a memory for storing a schedule; and
a scheduler for composing a schedule, wherein the processor generates a second query message upon composing the schedule; the processor further transmits the second query message to a receiving station; the processor further receives and records a second response message from the receiving station.

11. The electrical device as claimed in claim 9, wherein the first query message comprises a voice message.

12. The electrical device as claimed in claim 9, wherein the first query message comprises a text message.

13. The electrical device as claimed in claim 9, wherein the first query message comprises a meeting request.

14. The electrical device as claimed in claim 9, wherein the first response message comprises a voice message.

15. The electrical device as claimed in claim 9, wherein the first response message comprises a text message.

16. The electrical device as claimed in claim 9, wherein the first response message comprises a dual tone multifrequency response.

17. A method of scheduling meetings in a wireless communication system, the method comprising the steps of:
composing a schedule;
generating a first query message upon composing the schedule;
transmitting the first query message to a receiving station;
receiving a first response message from the receiving station; and
recording the first response message upon receiving the first response message.

18. The method as claimed in claim 17, wherein the first query message comprises a voice message.

19. The method as claimed in claim 17, wherein the first query message comprises a text message.

20. The method as claimed in claim 17, wherein the first query message comprises a meeting request.

21. The method as claimed in claim 17, wherein the first response message comprises a voice message.

22. The method as claimed in claim 17, wherein the first response message comprises a text message.

23. The method as claimed in claim 17, wherein the first response message comprises a dual tone multifrequency response.

24. A method of scheduling meetings in a wireless communication system, the method comprising the steps of:
receiving a first query message from a transmitting station;
recording the first query message upon receiving the first query message;
generating a first response message upon recording the first query message; and
transmitting the first response message to the transmitting station.

25. The method as claimed in claim 24, the method further comprising the steps of:
composing a schedule;
generating a second query message upon composing the schedule;
transmitting the second query message to a receiving station;
receiving a second response message from the receiving station; and
recording the second response message upon receiving the second response message.

26. The method as claimed in claim 24, wherein the first query message comprises a voice message.

27. The method as claimed in claim 24, wherein the first query message comprises a text message.

28. The method as claimed in claim 24, wherein the first query message comprises a meeting request.

29. The method as claimed in claim 24, wherein the first response message comprises a voice message.

30. The method as claimed in claim 24, wherein the first response message comprises a text message.

31. The method as claimed in claim 24, wherein the first response message comprises a dual tone multifrequency response.
